(19) United States
(12) Patent Application Publication
(10) Pub. No.: US 2002/0088961 A1
(43) Pub. Date: Jul. 11, 2002

(54) Valve having improved water sealing structure

(76) Inventor: Chi Yang, Taichung (TW)

Correspondence Address: Chi Yang, P.O. Box63-99, Taichung, 406, TW

(21) Appl. No.: 09/759,546

(22) Filed: Jan. 10, 2001

(51) Int. Cl. F16K 31/50; F16K 41/04

(52) U.S. Cl. 251/214

(57) ABSTRACT

A valve includes a valve seat formed between a water inlet and a water outlet, a valve stem threaded to the valve housing with a threaded engagement and having a plug secured to one end for engaging with the valve seat. A water tight seal is further formed between the valve stem and the valve housing when the plug is moved to engage with and to be disengaged from the valve seat, in order to block and to prevent the water from flowing or leaking through the threaded engagement formed between the valve housing and the valve stem.

### BACKGROUND OF THE INVENTION

1. Field of the Invention

The present invention relates to a valve, and more particularly to a valve having an improved water sealing structure.

2. Description of the Prior Art

One of the typical faucets or valves is disclosed in FIGS. 1 and 2, and comprises a valve body or a valve housing 10 including a valve seat 14 formed or provided between an outlet 15 and an inlet 17, a valve stem 11 threaded to the valve body 10 with a threaded engagement 18 and having a piston or plug 13 secured to the bottom thereof for engaging with the valve seat 14 and for blocking the water passage between the outlet 15 and the inlet 17. A knob 12 is secured on top of the valve stem 11 for rotating the valve stem 11 and for actuating the plug 13 to engage with and to be disengaged from the valve seat 14. However, once the plug 13 is disengaged from the valve seat 14, the water may flow through the valve seat 14 and may flow into the valve body 10 and may have a good chance to leak through the threaded engagement 18 between the valve stem 11 and the valve body 10.

The present invention has arisen to mitigate and/or obviate the afore-described disadvantages of the conventional valves.

### SUMMARY OF THE INVENTION

The primary objective of the present invention is to provide a valve having an improved water sealing structure.

In accordance with one aspect of the invention, there is provided a valve comprising a valve housing including a chamber and a water inlet and a water outlet formed therein, and including a valve seat provided between the water inlet and the water outlet of the valve housing, a valve stem threaded to the valve housing with a threaded engagement and including a first end movably received in the chamber of the valve housing, a plug secured to the first end of the valve stem for being actuated to engage with the valve seat by the valve stem, and means for making a water tight seal between the valve stem and the valve housing when the plug is moved to engage with and to be disengaged from the valve seat. The water may thus be prevented from flowing or leaking through the threaded engagement formed between the valve stem and the valve housing even when the valve stem is rotated and moved relative to the valve housing.

The water tight seal making means includes a casing provided in the valve housing, and a piston secured to the valve stem and slidably engaged with the casing, and includes a sealing ring engaged on the piston and slidably engaged with the casing for making a water tight seal between the casing and the piston and for preventing the water from flowing or leaking through the threaded engagement formed between the valve stem and the valve housing.

The casing includes a free end, the valve further includes a sealing ring secured to the plug for engaging with the free end of the casing and for further preventing the water from flowing into the casing when the sealing ring is engaged with the free end of the casing.

A sealing ring is further secured to the plug for engaging with the valve seat and for making a water tight seal between the plug and the valve seat and for effectively preventing water from flowing through the valve seat.

Further objectives and advantages of the present invention will become apparent from a careful reading of a detailed description provided hereinbelow, with appropriate reference to accompanying drawings.

### BRIEF DESCRIPTION OF THE DRAWINGS

FIGS. 1 and 2 are cross sectional views illustrating the conventional valves; and

FIGS. 3 and 4 are cross sectional views illustrating the valve in accordance with the present invention.

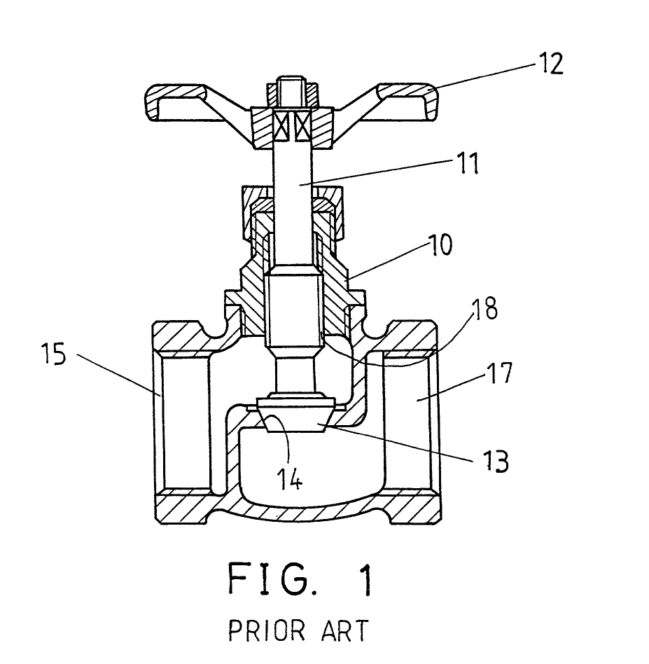

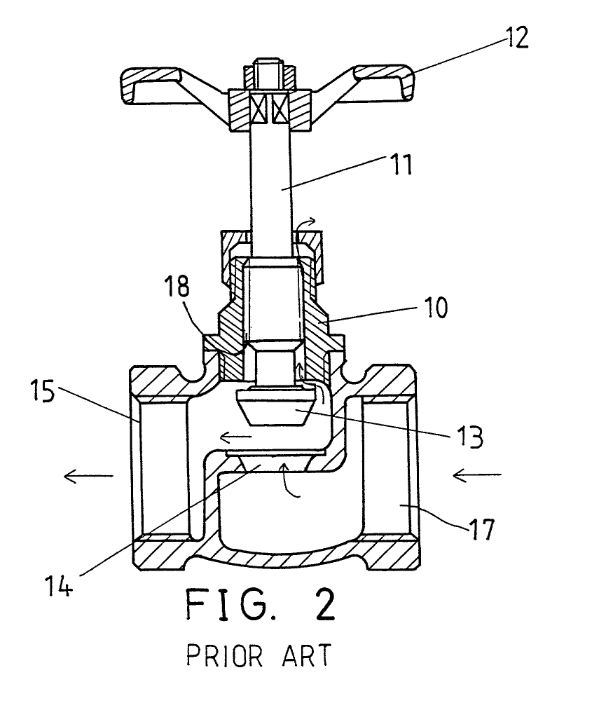

### DETAILED DESCRIPTION OF THE PREFERRED EMBODIMENT

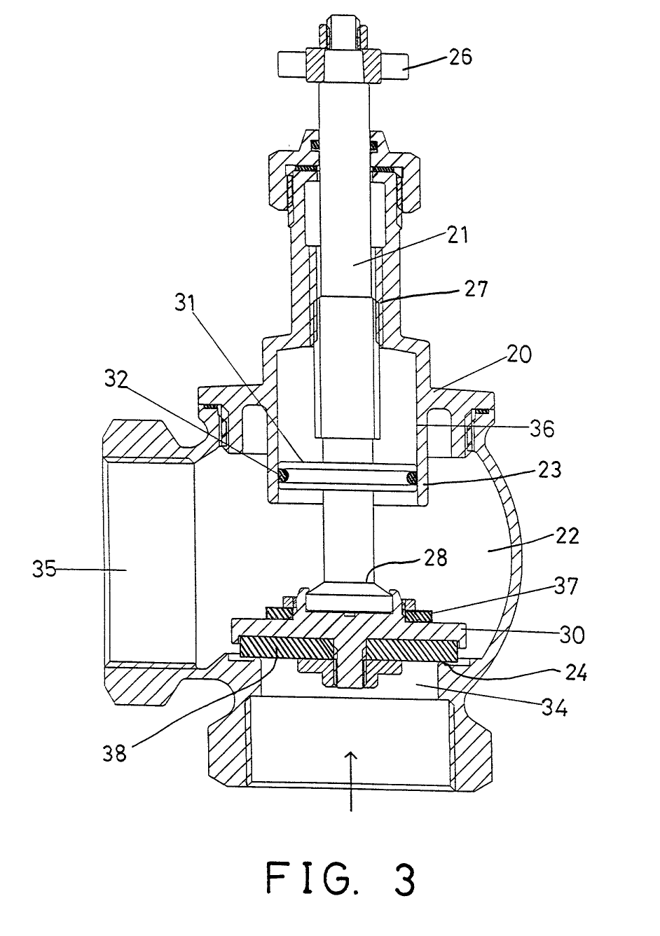

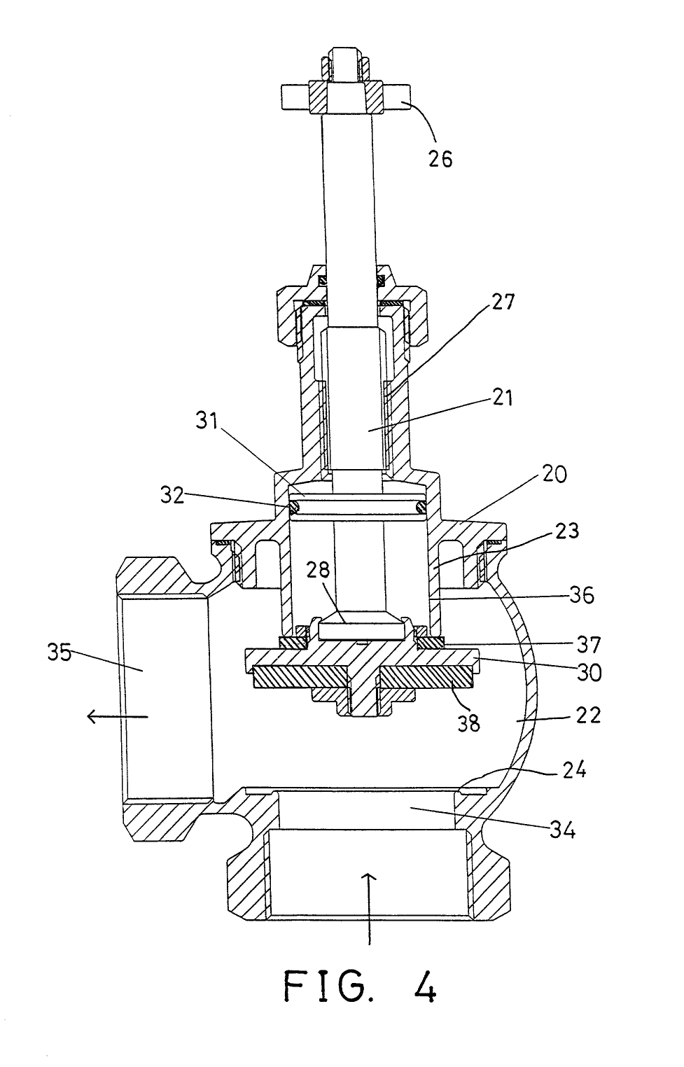

Referring to FIGS. 3 and 4, a valve in accordance with the present invention comprises a valve body 20 including a chamber 22 formed therein and including a valve seat 24 formed or provided in the chamber 22 thereof and located or formed between a water outlet 35 and a water inlet 34, and including a casing, such as a cylindrical casing 23 extended downward and inward of the chamber 22 of the valve housing 20 and having an inner peripheral surface 36 formed therein.

A valve stem 21 is threaded to the valve housing 20 with a threaded engagement 27 and includes a knob 26 secured on top thereof for rotating the valve stem 21 relative to the valve housing 20 and thus for moving the valve stem 21 inward and outward of the valve housing 20. The valve stem 21 includes a free end, such as a bottom end 28 received in the chamber 22 of the valve housing 20 and extendible outward or downward through the cylindrical casing 23 (FIG. 3).

A piston 31 is provided or attached or secured on the lower or middle portion of the valve stem 21 and provided between the threaded engagement 27 and the lower end 28 of the valve stem 21 and slidably received in the cylindrical casing 23. A sealing ring 32 is engaged on the outer peripheral portion of the piston 31 and slidably engaged with the inner peripheral surface 36 of the cylindrical casing 23 for making a water tight seal between the casing 23 and the piston 31 and thus the valve stem 21, and for preventing the water from flowing or leaking through the threaded engagement 27 formed between the valve housing 20 and the valve stem 21.

A plug 30 is secured to the bottom end 28 of the valve stem 21 and movable by the valve stem 21 to engage with the valve seat 24 and to block the water passage between the outlet 35 and the inlet 34, and/or to engage with the bottom end of the casing 23 and to block the water from entering into the casing 23 and to further prevent the water from leaking through the threaded engagement 27 formed between the valve housing 20 and the valve stem 21. A gasket or a sealing ring 37 is secured on the upper portion of the plug 30 for engaging with the bottom end of the casing 23, and another gasket or sealing ring 38 is secured on the lower portion of the plug 30 for engaging with the valve seat 24 and for blocking the water from flowing through the valve seat 24.

In operation, when the valve stem 21 is threaded or moved relative to the valve housing 20 and when the plug 30 is moved between the valve seat 24 and the bottom end of the casing 23, the piston 31 and/or the sealing ring 32 may always be engaging with the inner peripheral surface 36 of the casing 23 to make a water tight seal between the casing 23 and the piston 31 and thus the valve stem 21 and may thus be used for preventing the water from leaking through the threaded engagement 27 formed between the valve housing 20 and the valve stem 21. The sealing rings 37, 38 of the plug 30 may be used for effectively engaging with the bottom end of the casing 23 and for engaging with the valve seat 24 respectively.

Accordingly, the valve in accordance with the present invention includes an improved water sealing structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A valve comprising:
a valve housing including a chamber and a water inlet and a water outlet formed therein, and including a valve seat provided between said water inlet and said water outlet of said valve housing,
a valve stem threaded to said valve housing with a threaded engagement and including a first end movably received in said chamber of said valve housing,
a plug secured to said first end of said valve stem for being actuated to engage with said valve seat by said valve stem, and
means for making a water tight seal between said valve stem and said valve housing when said plug is moved to engage with and to be disengaged from said valve seat.

2. The valve according to claim 1, wherein said water tight seal making means includes a casing provided in said valve housing, and a piston secured to said valve stem and slidably engaged with said casing.

3. The valve according to claim 2, wherein said water tight seal making means further includes a sealing ring engaged on said piston and slidably engaged with said casing for making a water tight seal between said casing and said piston.

4. The valve according to claim 2, wherein said casing includes a free end, said valve further includes a sealing ring secured to said plug for engaging with said free end of said casing and for preventing water from flowing into said casing when said sealing ring is engaged with said free end of said casing.

5. The valve according to claim 1 further comprising a sealing ring secured to said plug for engaging with said valve seat and for making a water tight seal between said plug and said valve seat and for preventing water from flowing through said valve seat.
